(19) United States
(12) Patent Application Publication
(10) Pub. No.: US 2005/0040719 A1
(43) Pub. Date: Feb. 24, 2005

(54) Rotor bush, motor equipped therewith, and manufacturing methods therefor

(76) Inventors: Kenji Furuya, Matsudo-shi (JP); Noriyuki Yasaku, Matsudo-shi (JP)

Correspondence Address: MCGLEW AND TUTTLE, P.C., SCARBOROUGH STATION, SCARBOROUGH, NY, 10510-0827, US

(21) Appl. No.: 10/896,496

(22) Filed: Jul. 22, 2004

(30) Foreign Application Priority Data
Aug. 22, 2003 (JP) 2003-298342

(51) Int. Cl. H02K 5/24; H02K 5/16; H02K 7/08

(52) U.S. Cl. 310/90; 310/261; 310/51

(57) ABSTRACT

In order to position the rotor of the motor in the axial direction of the shaft, the rotor bush is placed in a prescribed position. This rotor bush comprises, all integrally machined from a planar metallic material, a shaft-contacting cylindrical wall section whose inner circumferential face constitutes a shaft press-in hole, a bearing-contacting section linked to an end of the shaft-contacting cylindrical wall section and formed in a planar shape, an outer cylindrical wall section extending from the outer circumferential side of the bearing-contacting section, and a plurality of claws formed at an end of the outer cylindrical wall section. By pressing the shaft into the shaft press-in hole of this rotor bush and bending and caulking the claws toward the surface of the shaft, the rotor bush is fixed to the shaft.

### BACKGROUND OF THE INVENTION

1. Field of the Invention

The present invention relates to a rotor bush fixed, in order to position a rotor in the axial direction of a shaft, in a prescribed position of the shaft in the axial direction, a motor equipped therewith, and manufacturing methods for the rotor bush and the motor.

2. Description of the Related Art

There is known a technique applicable to a small motor for use in a power tool, drier, printer or the like by which a rotor is positioned in the axial direction by fixing the rotor bush on the rotor shaft and supporting this rotor bush in the thrust direction with a bearing.

FIG. 11 and FIG. 12 illustrate a rotor bush embodying a first example of the prior art (see Patent Reference 1). FIG. 11 shows a state in which a rotor bush 21 is fitted on a shaft 1 to which a core 2 is fitted, and FIGS. 12(A) and 12(B) show sectional views of different rotor bushes each by itself.

A rotor bush 21 having a flanged shape as shown in FIG. 12(A) or a cylindrical rotor bush 21 formed in a grommet shape as shown in FIG. 12(B) is pressed into a shaft 1, and set in its tentative position. After that, it is firmly fixed by covering the rotor bush 21 to its peripheral face with an insulative coat 4. The rotor bush 21 is thereby fixed to the shaft 1 to perform the function of receiving the thrust.

The insulative coat 4 is formed by thinly coating with an adhesive, such as epoxy resin or the like, the flanks of the core 2, a portion of it around which a coil is to be wound, and the rotor bush portion between the core 2 and the rotor bush 21 and facing the shaft 1 and the core 2. After that, the insulative coat 4 is hardened by heating with a high frequency wave.

This hardening of the insulative coat 4 causes the rotor bush 21 to firmly stick to the shaft 1, and enables the coating to become an insulating film to perform electrical insulation.

As the rotor bush 21 is firmly stuck by the hardening of the insulative coat 4, when the rotor bush 21 is pressed in, even if the pressing force is rather weak, eventually a certain level of sticking force can be achieved, with the result that even a hard rotor bush, such as an iron bush punched out with a press, can be used.

However, if a large interference (=outer diameter of shaft−bore of rotor bush) is set, shaft flaws, bush burrs or shaft bending may arise. Or where a rotor bush of a hard material, such as iron, is used, unless it is pressed in with a reasonably weak force, the shaft may be injured. On the other hand, if the pressing force is too weak, the intention of placing the rotor bush in its tentative position cannot be achieved.

However, in an actual manufacturing process, it is difficult to keep the interference at a prescribed level of precision. Also, because the precision is dependent on the rotor bush by itself, the accuracy of its right angle relative to the shaft 1 often fails to be secured, and if it does fail, the inaccuracy should be corrected by cutting the face of the rotor bush 21 which is to come into contact with the bearing. Furthermore, while a soft bronze-made rotor bush 21 is often used to avoid injuring the shaft, a bronze-made rotor bush 21 cannot be directly exposed to a high frequency wave in the heating process for insulative coating. For this reason, the shaft 1 is heated with a high frequency wave, and the coating is accomplished with heat transmitted from the shaft 1, resulting in poor sticking of the insulative coat.

FIG. 13 shows a second example of the prior art in which a rotor bush is configured of a C ring. FIG. 13(A) shows the relationship of the C ring to the shaft onto which it is fitted, while FIG. 13(B) shows a sectional view of the C ring already fitted (see Patent Reference 2).

The rotor bush, consisting of a C ring 22 formed by bending a piano wire into a C shape, is press-snapped onto the shaft 1 fitted with the core 2. In this state, the inner face of the slot of the core 2 is covered with an insulative coat of epoxy resin or the like, this insulative coating is extended as far as to the circumferential face of the shaft 1 between the core and the C ring 22 and to circumferential face of the C ring 22 as shown in FIG. 13(B). This insulative coat 4 is formed by sticking insulative powder to the inner face of the core slot and the circumferential face of the C ring 22 in a state in which the core 2 is fitted onto the shaft 1, heating mainly the core 2 to melt the insulative powder with the heat of the core 2 and later cooling the core 2. After that, a coil is wound in the core slot. As this C ring 22 formed by shaping a piano wire in a C shape has a springy force, it can be readily placed in a prescribed position on the shaft 1, and its fitting work is simple.

However, as this C ring 22 is formed by shaping a piano wire in a C shape, the part of it in contact with a bearing 13 has no flat face and accordingly its contact with the bearing 13 is only by points, resulting in a high bearing pressure and an ensuing problem that the bearing 13 is easily worn out. Furthermore, as the C ring 22 has a seam, when the seam hits the bearing 13 when the motor is turning, noise occurs. In addition, because the C ring 22 and the shaft 1 are in contact with each other only by points, when the C ring 22 is fitted, it is difficult to achieve parallelism, and the ring tends to incline relative to the bearing face. There is an additional problem that the resistance to the pressure to shift is low (the C ring 22 is apt to be shifted on the shaft 1 in the axial direction).

[Patent Document 1]

Japanese Published Examined Patent Application No. 5-14505

[Patent Document 2]

Japanese Published Unexamined Utility Model Application No. 55-19472

### SUMMARY OF THE INVENTION

An object of the present invention is to solve these problems and to provide a rotor bush whose bearing pressure is lowered by eliminating any seam in the circumferential direction and keeping the bush in contact with the bearing face to face, resulting in reductions in the wear of the bearing and the noise during rotation.

Another object of the invention is to provide a rotor bush whose parallelism can be readily maintained and which makes it easy to keep parallelism and difficult to allow any inclination relative to the bearing face and is enhanced in resistance to pressure to shift by being brought into contact with the shaft face to face.

Still another object of the invention is not only to restrain the occurrence of shaft flaws, bush burrs or shaft bending by reducing the interference between the shaft and the rotor bush but also to improve the sticking of the insulative coat by making possible the use of ferrous material and thereby enabling rotor bush to be directly heated with a high frequency wave.

Yet another object of the invention is to do away with the dependence of accuracy on each individual rotor bush and the need for correction by cutting.

A rotor bush for use in a motor according to the invention is fixed, in order to position the rotor of the motor in the axial direction of a shaft, in a prescribed position of the shaft in the axial direction. This rotor bush comprises, all integrally machined from a planar metallic material, a shaft-contacting cylindrical wall section whose inner circumferential face constitutes a shaft press-in hole, a bearing-contacting section linked on the bearing side to an end of the shaft-contacting cylindrical wall section and formed in a planar shape, an outer cylindrical wall section extending from the outer circumferential side of the bearing-contacting section, and a plurality of claws formed at an end of the outer cylindrical wall section on the side reverse to the bearing-contacting section in the axial direction.

A motor according to the invention has a rotor bush fixed to the shaft by pressing the shaft into the shaft press-in hole in the rotor bush and bending and caulking the claws toward the surface of the shaft.

By a manufacturing method for a rotor bush for use in a motor according to the invention, the rotor bush is formed by machining a planar metallic material and linking integrally together a shaft-contacting cylindrical wall section, a bearing-contacting section linked to an end thereof and formed in a planar shape, an outer cylindrical wall section extending from the outer circumferential side of the bearing-contacting section, and a plurality of claws formed at an end of the outer cylindrical wall section.

By a version of the motor manufacturing method according to the invention, the rotor bush is fixed to the shaft by pressing the shaft into a hole bored in the shaft-contacting cylindrical wall section of the rotor bush to tentatively fix the rotor bush, with the claws directed toward the core, and then bending and caulking the claws toward the surface of the shaft.

Since the rotor bush according to the invention is in contact with the bearing face to face, the bearing pressure is low, resulting in little wear of the bearing.

Since the rotor bush according to the invention has no seam in the circumferential direction, little noise occurs during rotation.

Since the rotor bush according to the invention is in contact with the bearing face to face, it is easy to be kept in parallel, difficult to be inclined relative to the bearing face, and is enhanced in resistance to pressure to shift.

As no large interference is required between the shaft and the rotor bush (for instance 0 to 0.02 mm would be sufficient), according to the invention, there is no risk of occurrence of shaft flaws, bush burrs or shaft bending.

Since the rotor bush is set at a right angle to the shaft while being caulked in the configuration according to the invention, the precision is not dependent on the rotor bush by itself, and no correction by cutting is required either. In this procedure, the exact right angle can be formed because the plurality of claws of the rotor bush independently seize the shaft and the rotor bush is thereby fixed.

Since the invention permits the use of ferrous material, such as carbon steel, for the rotor bush, the rotor bush can be directly heated with a high frequency wave. As a result, the insulative coat sticks well.

### BRIEF DESCRIPTION OF THE DRAWINGS

FIG. 1 schematically shows a vertical section of a small motor to which the present invention is to be applied;

FIG. 2 shows an example of rotor bush having five claws, complete as a single unit;

FIG. 3 shows an example of rotor bush having three claws, complete as a single unit;

FIG. 4 illustrates an example of manufacturing of a single rotor bush;

FIG. 5 shows a state in which a rotor bush is firmly stuck onto a shaft to which a core is fitted;

FIG. 6 illustrates how insulative coating is applied to a rotor assembly;

FIG. 7 illustrates a first stage of a rotor bush sticking process;

FIG. 8 illustrates a second stage of the rotor bush sticking process;

FIG. 9 illustrates a third stage of the rotor bush sticking process;

FIG. 10 illustrates the final stage of the rotor bush sticking process;

FIG. 11 shows a rotor bush as a first example of the prior art;

FIGS. 12(A) and 12(B) show different forms of the rotor bush illustrated in FIG. 11 each by itself; and

FIG. 13 shows a second example of the prior art in which a rotor bush is configured of a C ring.

### DETAILED DESCRIPTION OF THE PREFERRED EMBODIMENTS

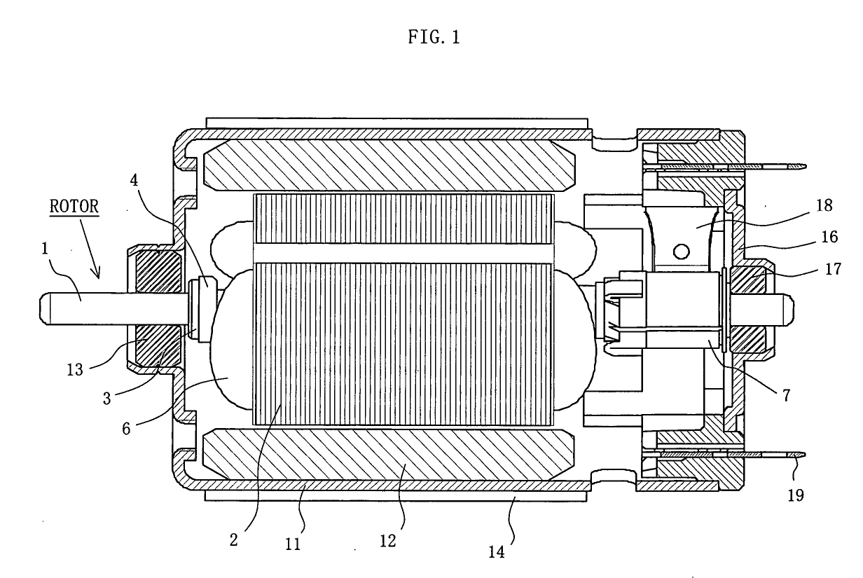

FIG. 1 schematically shows a vertical section of a small motor to which the present invention is to be applied, and this motor has a usual motor configuration except for the rotor bush. A rotor is configured by fitting a core 2, a coil 6 and a commutator 7 onto a shaft 1. In the drawing, reference numeral 3 denotes a rotor bush which positions the rotor in the axial direction, over which an insulative coat 4 is applied.

In the drawing, reference numeral 11 denotes a cylindrical hollow metallic motor case having a bottom, to whose inner circumferential face is fixed a magnet 12 (illustrated to be bipolar) to serve as a stator magnetic pole, and at the center of the bottom of the motor case 11 is integrally disposed a cylindrical protruding section for accommodating the bearing 13, i.e. the bearing supporting section. Reference numeral 14 denotes a yoke, which is formed of a highly magnetic material, such as an iron sheet, in a substantially cylindrical shape and firmly stuck to the outer side face of the motor case 11 to secure a magnetic path by converging the magnetic flux from the magnet 12.

Into the opening of this motor case 11 is fitted a metallic case lid 16. At the center of this case lid 16 is disposed a cylindrical supporting section for accommodating a bearing 17, which is pressed in and fixed in the normal way. To this case lid 16 are also fitted, with a resin-made holder in-between, a brush 18 and a terminal 19 connected to it.

This small motor is assembled by fitting the case lid 16 provided with the brush 18 and the terminal 19 over the opening of the motor case 11, after pressing the shaft 1 of the rotor through the bearing 13, which is pressed into and fixed in the center bottom of the motor case 11 to which the magnet 12 is firmly stuck, while inserting the other end of the shaft 1 into the bearing 17 fixed to the case lid 16. In this process, the rotor bush 3 fixed to the shaft 1 positions the rotor in the thrust direction (the axial direction of the shaft).

To add, although the example described above has a configuration in which the rotor bush 3 is in direct contact with the bearing 13 in the thrust direction, it is also permissible as a normal practice as required to dispose between the rotor bush 3 and the bearing 13 an adjusting washer to minimize the end play, an anti-drip washer intended to prevent the flowing-out of the oil filling the air port section of the bearing 13 made of sintered alloy, or a thrust washer intended to prevent the rotor bush 3 and the bearing 13 from coming into direct contact with each other. At any rate, the bearing 13 not only supports the shaft 1 in the circumferential direction but also supports in the thrust direction via the rotor bush 3 the shaft 1 to which the bearing 13 is fixed.

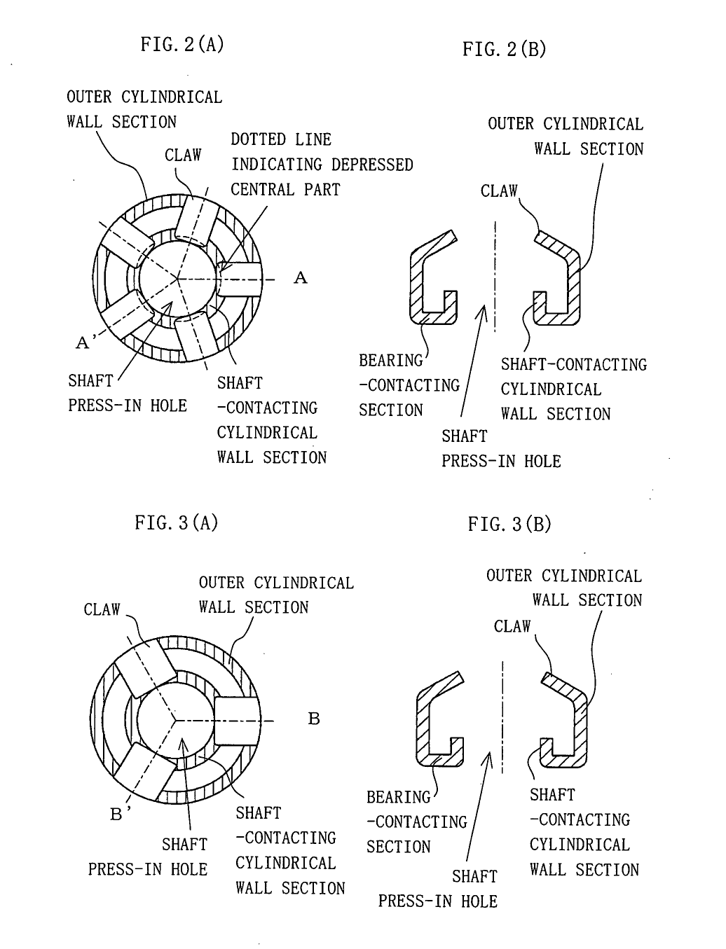

FIG. 2 illustrates an example of rotor bush having five claws, complete as a single unit, FIG. 2(A) depicting the rotor bush from the claw side and FIG. 2(B) showing a section cut along line A-A. FIG. 3 illustrates a similar example to what is shown in FIG. 2, only differing in that this rotor bush has only three claws.

The rotor bush comprises a shaft-contacting cylindrical wall section whose inner circumferential face constitutes a shaft press-in hole, a bearing-contacting section linked on the bearing side to an end of the shaft-contacting cylindrical wall section and formed on a plane normal to the axis of the shaft, an outer cylindrical wall section extending from the outer circumferential side of and integrally with the bearing-contacting section, and a plurality of claws formed at an end of the outer cylindrical wall section on the side opposite the core on the side reverse to the bearing-contacting section in the axial direction, all integrally machined from a planar metallic material. Preferably, the number of the claws should be three to seven. At the time of assembling the rotor, the shaft is pressed into the shaft press-in hole formed by the shaft-contacting cylindrical wall section. Also at the time of assembling the rotor, the tips of the claws are bent and caulked so that the claws be firmly pressed against the shaft. To add, it is also possible in this process to depress the middle part of each claw tip along the round contour of the shaft as indicated by a dotted line in FIG. 2(A), but the point contact between the contour of the shaft and each claw tip, linearly or slightly convexly shaped as indicated by a solid line, gave rise to no problem.

As the claws are bent and caulked in the position of the rotor bush which is tentatively fixed by being pressed in and the rotor bush is thereby firmly fixed to the shaft, no large sticking power is required at the time of its pressing in. Since no large interference is thus required between the shaft and the rotor bush, there is no risk of occurrence of shaft flaws, bush burrs or shaft bending. Nor is it necessary to choose a soft metal as the material of the rotor bush, but a ferrous material can be used, which is suitable for heating with a high frequency wave in the coating process.

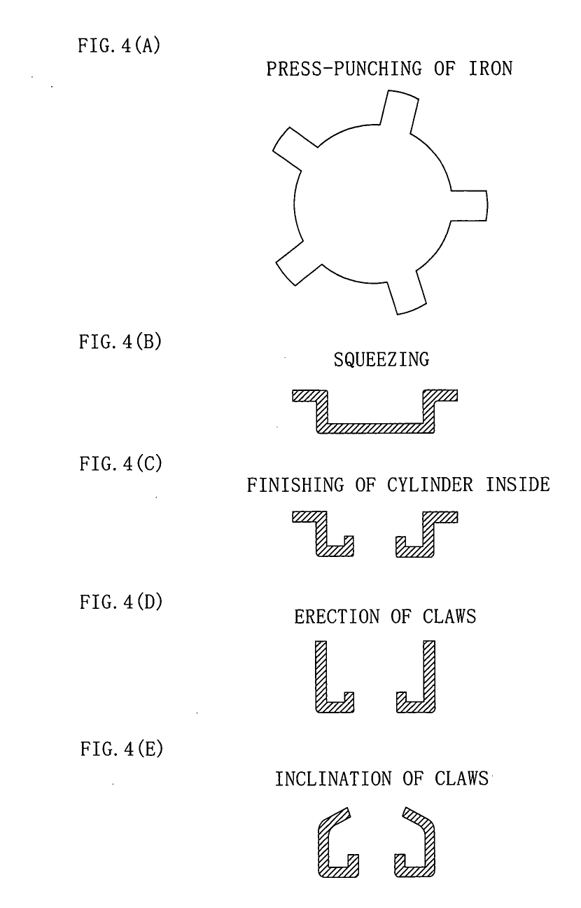

FIG. 4 illustrates an example of manufacturing of a single rotor bush. First, as shown in FIG. 4(A), a planar metallic material, such as an iron sheet of 0.2 mm to 0.7 mm in thickness, is punched with a press. At the time of this punching, three to seven claws are formed on the outer circumference. Then, as shown in FIG. 4(B), the material is squeezed into a bag shape. In this way are formed a flat part where the bearing-contacting section is to be formed, the outer cylindrical wall section and the claws shaped by bending outward corresponding parts of this outer cylindrical wall section at a right angle. The reason for this outward bending of the claws lies in the convenience of the next boring procedure.

Next, as shown in FIG. 4(C), a hole to let the shaft penetrate is bored, followed by burring to expand the hole and finish its part to come into contact with the shaft into a facial shape (inner face of the cylinder). Then, as shown in FIG. 4(D), the claws are erected. Further, as shown in FIG. 4(E), the claws are inclined to complete a single rotor bush.

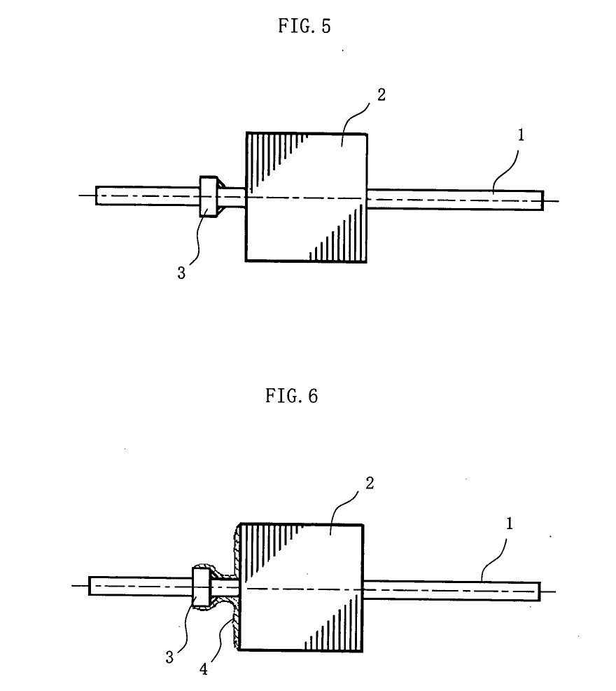

FIG. 5 shows a state in which a rotor bush is firmly stuck, by bending the claws even deeper after the rotor bush is pressed in, onto the shaft 1 to which the core is fitted.

This firm sticking of the rotor bush will now be described with reference to FIG. 7 through FIG. 10. FIG. 7 through FIG. 10 illustrate different stages of the rotor bush sticking process. The rotor bush 3 is inserted in a tentatively pressed-in state toward the tip side of the shaft 1, to which the core 2 is fitted, to compose a rotor assembly. In this process, the rotor bush is so inserted that its claws be opposite the core. At this stage, no coil is as yet wound around the core of this rotor assembly. Nor is a rectifier fitted to it. This rotor assembly is arranged between a positioning block A and a positioning block C as shown in FIG. 7.

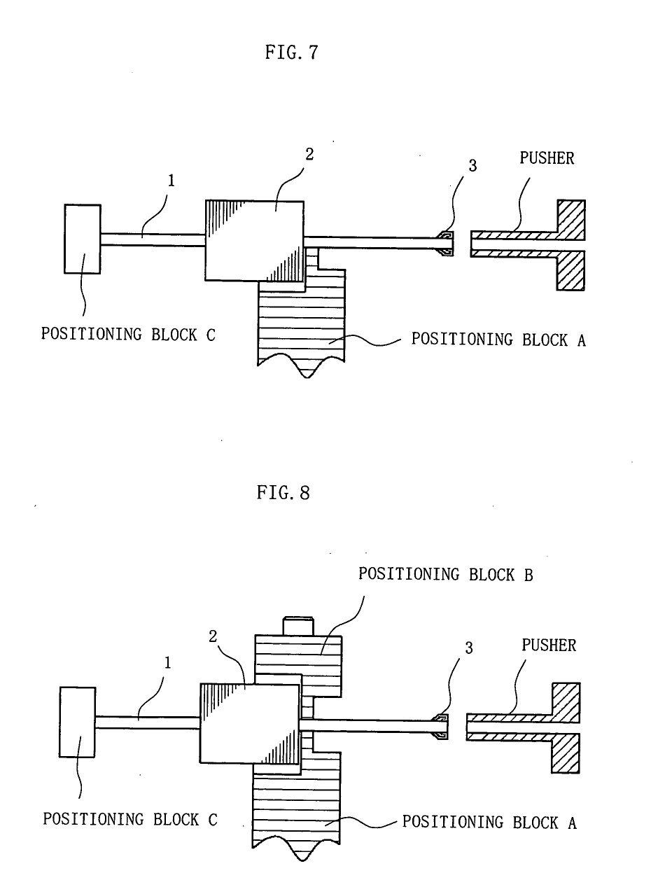

Then, as shown in FIG. 8, the rotor assembly is pinched between the positioning block A and a positioning block B paired with it in the circumferential direction. In this procedure, the fitting should be done nicely with respect to the shaft. Namely, while some gaps should be left between the outer circumferential face of the core 2 and the positioning blocks A and B, no gaps should be allowed between the shaft in its circumferential direction and the positioning blocks A and B. The respective faces of the positioning blocks A and B in contact with the shaft are semicircular concaves which, when brought together, constitute a full circle having substantially the same diameter as the shaft. The positioning block C establishes positioning in the axial direction of the rotor assembly.

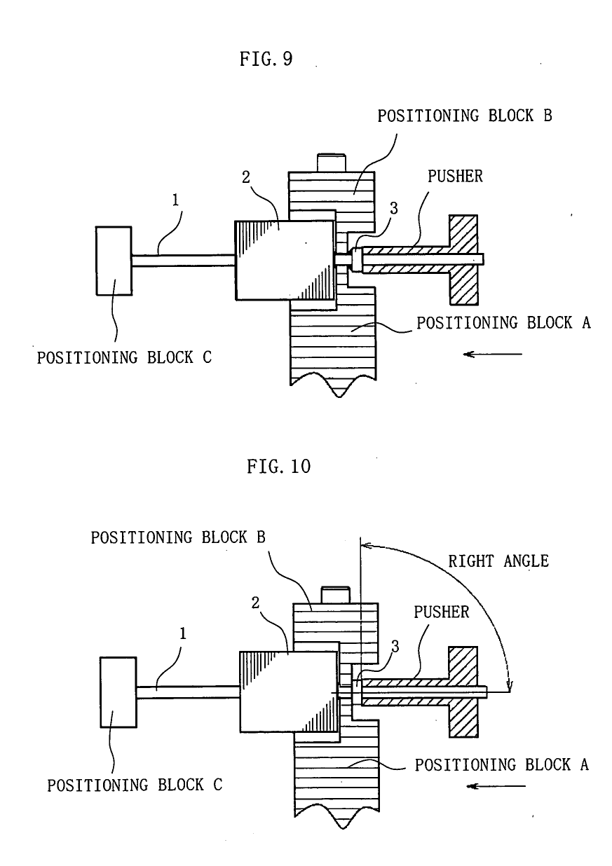

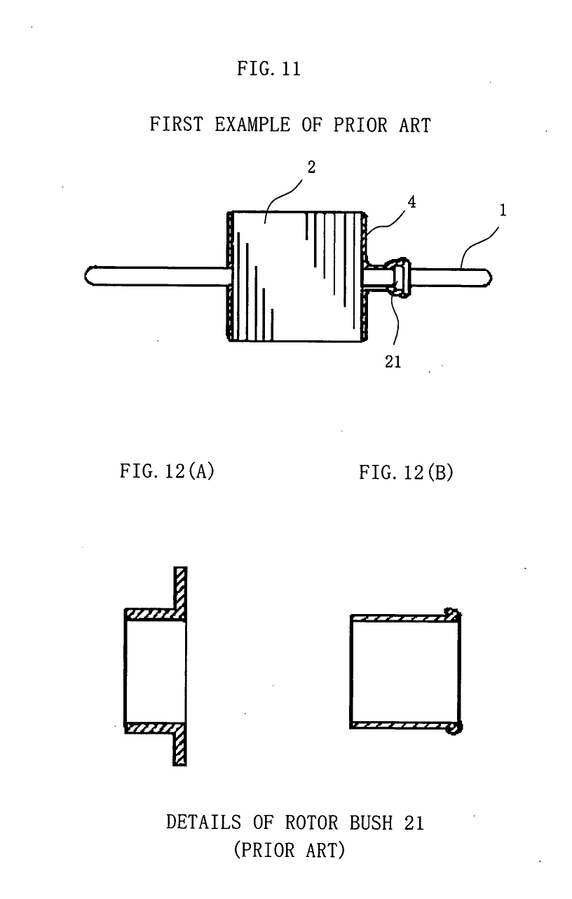

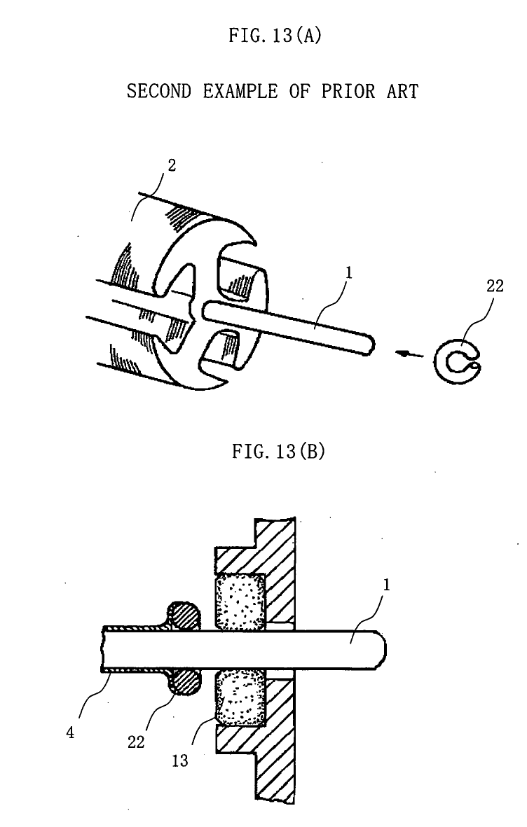

Next, as shown in FIG. 9, a pusher is advanced to press the rotor bush 3 into its prescribed fixed position. From this state, the pusher is further advanced to begin bending the claws of the rotor bush 3. The pusher has a long hole whose bore allows exact insertion of the fixed shaft with no gap around and a flat rotor bush suppressing face. Opposing this movement of the pusher, the positioning blocks A and B support the claws in their respectively prescribed positions.

Then, as shown in FIG. 10, the pusher is further advanced to the end of a predetermined stroke to further bend the claws. The tips of the bent claws then are strongly pressed against the surface of the shaft. As a result, the rotor bush 3 is firmly stuck to the shaft 1. At the same time, the bearing-contacting face of the rotor bush 3 is in a state in which a right angle is formed with respect to the shaft. Thus, the axis of the hole in the pusher into which the shaft is to be inserted and the rotor bush suppressing face of the pusher form an exact right angle. In this procedure, the exact right angle can be formed because the plurality of claws of the rotor bush independently seize the shaft and are thereby fix the rotor bush. As the present invention thus provides for a configuration in which a right angle is formed with respect to the shaft while the rotor bush is being caulked, the right angle can be exactly formed by the time the caulking is finished without relying on the precision of the rotor bush by itself.

The rotor assembly completed in this way has the configuration shown in FIG. 5 as described above. Then by applying the insulative coat 4 to this rotor assembly as shown in FIG. 6, the shaft 1 and the rotor bush 3 are stuck even more firmly to each other. This insulative coat 4 itself can be applied by any appropriate method conventionally used. Thus, whereas an insulative coat of epoxy resin or the like is laid over the inner face of the slot in the core 2, when it is laid, the coat is extended to the circumferential face of the shaft 1 between the core 2 and the rotor bush 3 and to the circumferential face of the rotor bush 3. This insulative coat 4 is formed by sticking insulating powder to the inner face of the core slot and the circumferential face of the rotor bush 3 in a state in which the core 2 is fitted to the shaft 1, and the insulative powder is melted by heating with a high frequency wave afterwards. Then, after cooling the core 2, the coil is wound round the core slot.

Since the present invention, as described above, permits the use of ferrous material, such as carbon steel, for the rotor bush, not only the core 2 and the shaft 1 but also the rotor bush 3 can be directly heated with a high frequency wave, and accordingly the insulative coat 4 sticks well.

The usual requirements for a rotor bush include a shake angle (the degree of non-uniformity of the right angle with respect to the axis of the shaft in the circumferential direction) of not more than 10μ for instance where the specifications allow cutting (the aforementioned specifications regarding correction of the rotor bush by cutting) or not more than 30μ where the specifications allow no cutting, and the resistance against coming off of not less than 35 kg for instance. According to the invention, an average shake angle of 6μ and an average anti-coming-off resistance of 70 kg have been successfully achieved. The reduced shake angle contributes to reducing the noise arising from contact with the bearing.

1. A rotor bush for use in a motor fixed, in order to position the rotor of the motor in the axial direction of a shaft, in a prescribed position of the shaft in the axial direction, comprising, all integrally machined from a planar metallic material:
a shaft-contacting cylindrical wall section whose inner circumferential face constitutes a shaft press-in hole,
a bearing-contacting section linked on the bearing side to an end of said shaft-contacting cylindrical wall section and formed in a planar shape,
an outer cylindrical wall section extending from the outer circumferential side of the bearing-contacting section, and
a plurality of claws formed at an end of said outer cylindrical wall section on the side reverse to said bearing-contacting section in the axial direction.

2. A motor to which a rotor bush is fixed, in order to position the rotor in the axial direction of a shaft, in a prescribed position of the shaft in the axial direction, wherein:
the rotor bush having a shaft-contacting cylindrical wall section whose inner circumferential face constitutes a shaft press-in hole, a bearing-contacting section linked on the bearing side to an end of said shaft-contacting cylindrical wall section and formed in a planar shape, an outer cylindrical wall section extending from the outer circumferential side of the bearing-contacting section, and a plurality of claws formed at an end of said outer cylindrical wall section is integrally machined from a planar metallic material,
the rotor bush being fixed to the shaft by pressing the shaft into said shaft press-in hole in said rotor bush and bending and caulking said claws toward the surface of the shaft.

3. The motor according to claim 2, wherein the fixation of said fixed rotor bush is further strengthened by applying an insulative coat over the rotor bush.

4. A manufacturing method for a rotor bush for use in a motor whereby a rotor bush is fixed in a prescribed position in the axial direction of the shaft in order to position the rotor of the motor in the axial direction of the shaft, comprising steps of:
machining a planar metallic material; and
linking integrally together a shaft-contacting cylindrical wall section, a bearing-contacting section linked to an end thereof and formed in a planar shape, an outer cylindrical wall section extending from the outer circumferential side of the bearing-contacting section, and a plurality of claws formed at an end of the outer cylindrical wall section.

5. A manufacturing method for a motor whereby a rotor bush is fixed in a prescribed position in the axial direction of the shaft in order to position a rotor in the axial direction of the shaft, comprising steps of:
forming the rotor bush in which a shaft-contacting cylindrical wall section, a bearing-contacting section linked to an end thereof and formed in a planar shape, an outer cylindrical wall section extending from the outer circumferential side of the bearing-contacting section, and a plurality of claws formed at an end of the outer cylindrical wall section are linked integrally together by machining a planar metallic material; and
fixing the rotor bush to the shaft by pressing the shaft into a hole bored in said shaft-contacting cylindrical wall section to tentatively fix said rotor bush, with the claws directed toward the core, and then bending and caulking said claws toward the surface of the shaft.

6. The motor manufacturing method according to claim 5, whereby the fixation of said fixed rotor bush is further strengthened by applying an insulative coat over the rotor bush after fixing said claws by caulking.
